(19) United States
(12) Patent Application Publication
(10) Pub. No.: US 2018/0339894 A1
(43) Pub. Date: Nov. 29, 2018

(54) CHILLED ALCOHOLIC BEVERAGE DISPENSER

(71) Applicants: Tap Machine Inc., (US); Mast-Jagermeister SE, (US)

(72) Inventor: Jimmy Chu, Park Ridge, NJ (US)

(73) Assignee: Tap Machine Inc., New Rochelle, NY (US)

(21) Appl. No.: 13/873,643

(22) Filed: Apr. 30, 2013

Related U.S. Application Data
(60) Provisional application No. 61/643,471, filed on May 7, 2012.

(51) Int. Cl. B67D 1/08; B67D 3/00

(52) U.S. Cl. CPC B67D 1/0859; B67D 3/0009

(57) ABSTRACT

A machine dimensioned so as to be placed on the countertop of a bar for dispensing chilled alcoholic beverage includes a housing forming an enclosure with a beverage faucet having a handle mounted on its front outer surface. The enclosure provides a cooled interior section and a noncooled interior section. Heat-generating portions of a refrigeration cooling unit are contained in the noncooled interior portion. The cooled interior portion provides a beverage container mount configured to removably receive a stopper shaft of a bottle stopper which is fluidly connected via a manifold so an inclined beverage container can supply beverage to a beverage storage tank. A portion of an evaporator coil of the refrigeration cooling unit is located within the beverage storage tank for further cooling the alcoholic beverage. Chilled alcoholic beverage is transferred from the beverage storage tank to the beverage faucet via a beverage delivery tube fluidly connecting the beverage storage tank to the beverage faucet.

### BACKGROUND OF THE INVENTION

### 1. Field of the Invention

This invention relates to a machine for dispensing beverages including a refrigeration cooling unit contained within a housing. More particularly, the present invention relates to a refrigerated beverage dispensing machine in which a beverage container is invertedly mounted within the housing for delivering highly chilled alcoholic beverage to a beverage faucet mounted on a side of the housing in a home or casual environment.

### 2. Brief Description of the Background Art

Most conventional vapor-compression cooling systems, and particularly those employed for beverages, include fundamental components such as an evaporator, a compressor with an expansion valve, and condenser. As is very well-understood in the art, the evaporator, or cold section, allows a pressurized refrigerant to expand, boil and evaporate. During this change of state from liquid to gas, energy (heat) is absorbed. The compressor acts as a refrigerant pump and recompresses the gas to a liquid with the expansion valve serving to separate the low and high pressure gases. The condenser expels the heat absorbed by the evaporator and produced during compression into the ambient environment.

These conventional vapor-compression refrigerant systems are very adequate for large or open-air cooling needs. However, it is desirable to dispense some beverages such as spirits or specialty liqueurs, that are more viscous than most beer and wines and have higher alcohol contents, i.e., about thirty-five percent, from artistically designed bottles placed on or within compact, artistically designed dispensing machines. The bottles are typically inclined, e.g., inverted or slanted, and mounted atop the machine. The beverage is withdrawn from the bottles and cooled by the refrigerant unit contained inside the machine. The machines are typically table top units or placed on shelves or bars and are highly visible to the public.

It can be difficult to fit a conventional refrigeration system within small machines such as table top units for use in bars or homes. These units typically accommodate three bottles, but nevertheless still require a compressor, refrigerator coil, condenser, pump, fan, and other associated refrigeration equipment but such must be placed in a restricted compact housing. Close packaging of these systems increases the complexity of the units and exacerbates their internal heat generation. This adds both to the cost of the overall units and their daily operating cost.

A simpler, less massive refrigeration may be provided by thermoelectric cooling using the Peltier effect to create a heat flux between the junction of two different types of materials. A Peltier cooler, heater, or thermoelectric heat pump is a simple solid-state active heat pump which transfers heat from one side of the device to the other side against the temperature gradient (from cold to hot), with consumption of electrical energy. Machines for dispensing chilled beverages using thermoelectric cooling units are taught in U.S. Pat. No. 5,494,195. However, these devices cannot supply adequately chilled beverages on demand.

In one known cooling system for alcoholic beverages, a chiller coil is in intimate contact with the evaporator coil of a refrigeration cooling unit, and a constant vapor pressure is maintained on the refrigerant in the evaporator coil so that the coolant in the chiller coil is cooled to a substantially constant temperature. The chiller coil, evaporator coil, and associated equipment are provided in a closed housing.

An example of this type of unit disclosed in U.S. Pat. No. 4,949,552 provides an insulated container to hold the coolant. While the container acts as a holding tank for the coolant, no refrigeration takes place in the tank. Part of a chiller coil extends from the housing and is used to chill beer lines which may be placed concentrically about the chiller line. The unit can be placed out-of-sight and the beer lines can extend many feet from the housing to a tap or spigot. The unit maintains the beverage at a constant temperature while using only a small amount of both coolant.

Although this type of unit is advantageous for long beer line runs from a backroom area to a spigot, for some specialty beverages it is still more desirable to dispense from a bottle. Some of these prior art machines are disclosed in, for instance, U.S. Pat. Nos. 5,427,276 and 5,456,387. The bottles are typically mounted inverted on the machine, and beverage is withdrawn from the bottles for dispensation. The machine provides a small self-contained housing for controlling delivery of viscous alcoholic beverages such as a thick liqueur and may be placed on a tabletop of a bar or similar public environment where ornamental bottles are to be displayed.

Often these machines chill specialty beverages to temperatures below freezing, i.e. about 10-25° F., preferably about 15° F. Adequate chilling of the beverage is necessary although commercial necessities require maintaining the bottles on display, positioned on top of the machine housing in an inclined or inverted position. Thus, it is necessary to periodically withdraw liqueur from the bottles while: 1) ensuring that the bottles are displayed on the housing such as in an upside-down state to allow the viscous liquid to flow therefrom, 2) ensuring that the dispensed liqueur is adequately cooled even during high usage and dispensing activity, while 3) ensuring adequate control when dispensing the viscous beverage.

One such machine has a housing forming an enclosure and an outer surface. A refrigeration cooling unit is contained within the housing and includes a compressor, condenser and evaporator coil. A beverage faucet is mounted on the outer surface of the housing. A bottle mount is positioned on the top surface of the housing and mounts at least one inverted beverage container thereon. A manifold is mounted in the housing to receive beverage from the inclined beverage container. A beverage delivery tube is contained within the housing and is operatively connected to the beverage faucet and manifold for delivering beverage from beverage containers through the manifold to the beverage faucet. A portion of the beverage delivery tube extends coaxially within the evaporator coil to form a chilled beverage line for chilling any beverage flowing through the beverage delivery tube.

In this machine, the chilled beverage line must extend a sufficient distance to allow sufficient cooling of a beverage to about 15° F. The components and beverage line configuration take up greater space, requiring a larger housing, and requiring greater tabletop space when the housing is positioned on a bar or other table. Additionally, compressed coolant circulates throughout the chilled beverage line regardless of usage, wasting energy.

A different prior art machine connects a cooling tank mounted at a vertical height above the beverage faucet. In this machine beverage is received from the manifold into the tank. At least a portion of the evaporator coil surrounds or extends within the cooling tank and a beverage delivery tube connects between the cooling tank and the beverage faucet for delivering cooled beverage by gravity flow.

Prior art cooling systems for beverages have afforded both bars and homeowners with the opportunity to provide an enjoyable entertaining experience while dispensing cooled beverages. However, many deficiencies are involved with such beverage dispensers, such as not dispensing the cooled beverage at optimum temperature due to exposure of the previously-cooled liquid to the high heat environment within the dispenser prior to its release from the beverage faucet. Other common deficiencies include the beverage dispenser forming unsightly stains or puddles on the beverage faucet and/or the counter supporting the beverage dispenser, as well as achieving the proper temperature for consumption taking longer than desired, or dispensing the chilled beverage requiring an undue amount of time, etc.

### SUMMARY OF THE INVENTION

It is an object of the present invention to provide a sleek machine that dispenses chilled beverages and requires minimal shelf or table top space.

It is another object of the present invention to provide a machine that quickly delivers a serving of highly chilled viscous beverage.

These objects and others are attained by the present invention, which provides a portable machine that dispenses chilled alcoholic beverages having a housing forming an outer surface and an enclosure. A refrigeration cooling unit is contained within the housing and includes a compressor, condenser and evaporator coil. The enclosure provides a refrigerated (e.g., cooled) section and an unrefrigerated section housing the heat-generating components of the cooling system.

A bottle mount is positioned within the cooled section of the housing to removably secure one inclined, preferably inverted, beverage container. Once mounted, beverage fluid from the bottle is transported to a storage tank containing a cooling tube, where it is further chilled to a predetermined temperature. Chilled beverage from the storage tank is dispensed when desired through a beverage faucet is mounted on an outer surface of the housing adjacent the cooled section. The storage tank may be located below the inclined beverage container and above the beverage faucet so as to preclude need for an electric fluid pump.

### BRIEF DESCRIPTION OF THE DRAWINGS

The advantages of the present invention will be appreciated more fully from the following description, with reference to the accompanying drawings in which:

FIG. 1 is a perspective view of an embodiment of the machine of the present invention which dispenses chilled, viscous alcoholic beverage.

FIG. 2 is a partial cutaway elevation view of the machine of FIG. 1 showing arrangement of internal parts of the machine.

FIG. 3 is a perspective view of a locking socket used in accordance with the present invention.

FIG. 4 is a cutaway view of the locking socket of FIG. 3.

### DETAILED DESCRIPTION OF THE INVENTION

A machine dispenses viscous, chilled alcoholic beverage and has a housing forming an enclosure with side, top and bottom surfaces. The side, top and bottom surfaces are dimensioned to provide a housing sized to contain a beverage bottle while fitting on the countertop of a shelf or bar and the like. A refrigeration cooling unit is contained within the enclosure and includes a compressor, condenser and evaporator coil. A beverage faucet is mounted on the side surface of the housing.

A bottle mount is provided within the housing for receiving an upturned beverage bottle. The bottle mount is configured for receiving a stopper shaft of a bottle stopper affixed to the beverage bottle so that the bottle may be invertibly mounted in the housing. Beverage is received from the beverage bottle via manifold or a tube into a sealed beverage storage tank. A portion of the evaporator coil cools alcoholic beverage contained within the beverage storage tank to a suitable temperature. A beverage delivery tube fluidly connects between the beverage storage tank and the beverage faucet for delivering prechilled beverage from the beverage storage tank to the beverage faucet.

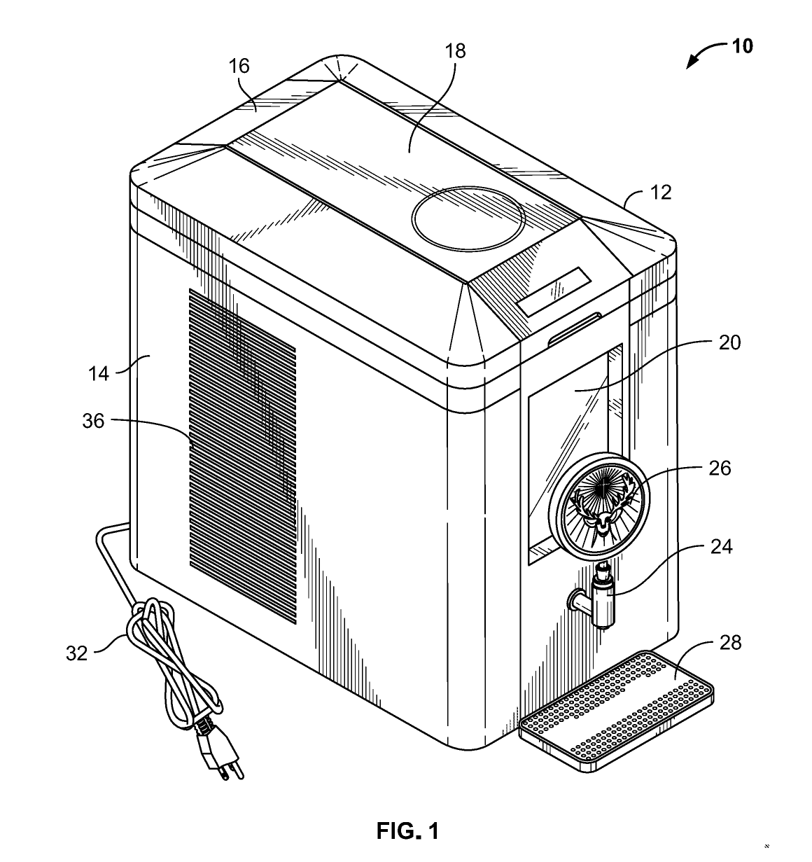

Referring now to FIG. 1, there is illustrated one embodiment of the machine 10 for dispensing chilled alcoholic beverages in accordance with the present invention. As illustrated therein, machine 10 includes a generally rectangular configured housing 12 having an outer surface with sidewalls 14 and a removable top provided by inwardly inclined top walls 16 converging to a flat top 18.

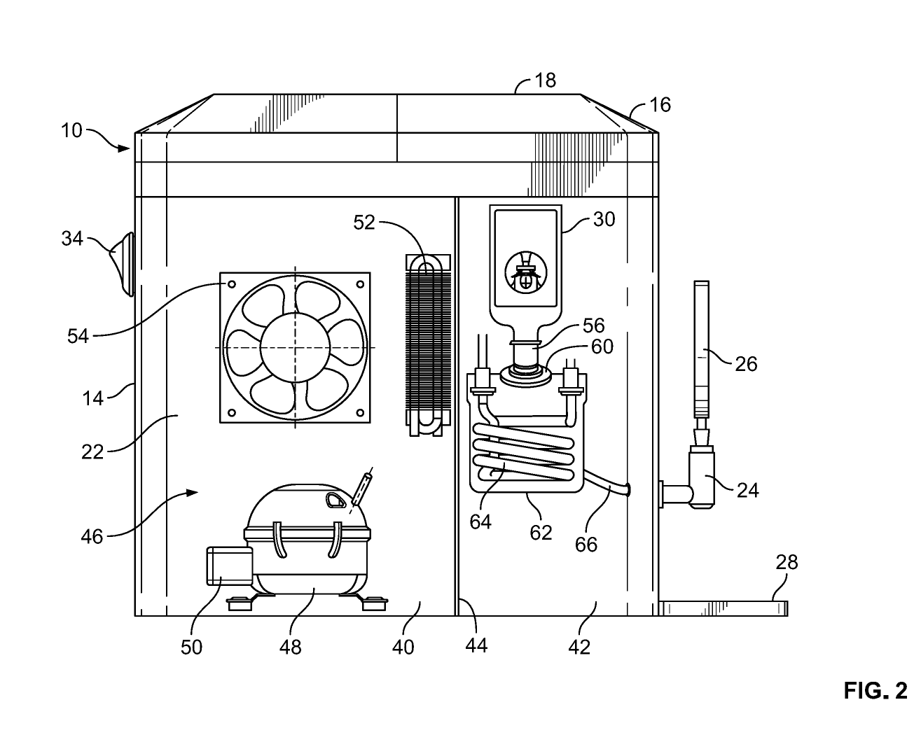

Machine 10 further provides in its front sidewall 14 a viewing window 20 for providing visual access to the interior 22 of housing 12 (best seen in FIG. 2) together with a beverage faucet 24 having decorative handle 26, and a drip tray 28. As explained below, pivoting decorative handle 26 displaces a faucet stop (unillustrated) permitting chilled beverage to be dispensed. Decorative handle 26 may provide a transparent or opaque branded commercial logo or personalized “lifestyle” design as illustrated to better inspire brand loyalty or desire of machine 10. Similarly, viewing window 20 and/or drip tray 28 may also feature an (unillustrated) branded logo or lifestyle design.

Viewing window 20 is located on front side wall so as to provide ready visual accessibility to beverage bottle 30 (best seen in FIG. 2) to ascertain both the fluid level of beverage remaining therein as well as to display its own ornamental design features.

The rear sidewall 14 of housing 12 provides an electrical cord 32 and a power switch 34, although these may be located elsewhere as desired. At least one sidewall 14 further provides cooling vents 36 to assist in extracting heat from within housing 12, as discussed below.

As shown in FIG. 2, interior 38 provides a noncooled interior portion or section 40 and a separate cooled interior portion or section 42 defined by insulating wall 44. Insulating wall 44 is mounted within housing 12 and extends substantially from side to side and top to bottom of interior 22.

Noncooled interior portion 40 contains the heat-generating elements of refrigeration cooling unit 46. The refrigeration cooling unit 46 includes a compressor 48 with expansion valve 50, condenser (unillustrated) and evaporator coil 52. Evaporator coil 52 is positioned on insulating wall 44 so as to extract heat from cooled section 42. Refrigeration cooling unit 46 uses a conventional refrigerant liquid such as Freon R-12® (dichlorodifluoromethane produced by DuPont), which expands to form a gas and condenses back to a liquid.

The compressor 48 compresses the vaporized low pressure gas to a high pressure gas and pumps the high pressure gas to the condenser. The condenser converts the high pressure gas to high pressure liquid by extraction of heat from the gas by passing air over evaporator coil 52. A fan 54 mounted over cooling vents 36 within noncooled interior section 40 expels heat extracted from cooled interior section 42 as well as heat generated by refrigeration cooling unit 46 and exhausts the same outside housing 12. A drier/strainer (unillustrated) traps residual moisture and any contaminants in the system. The refrigeration cooling unit 46 also includes a start relay and overload protector (unillustrated).

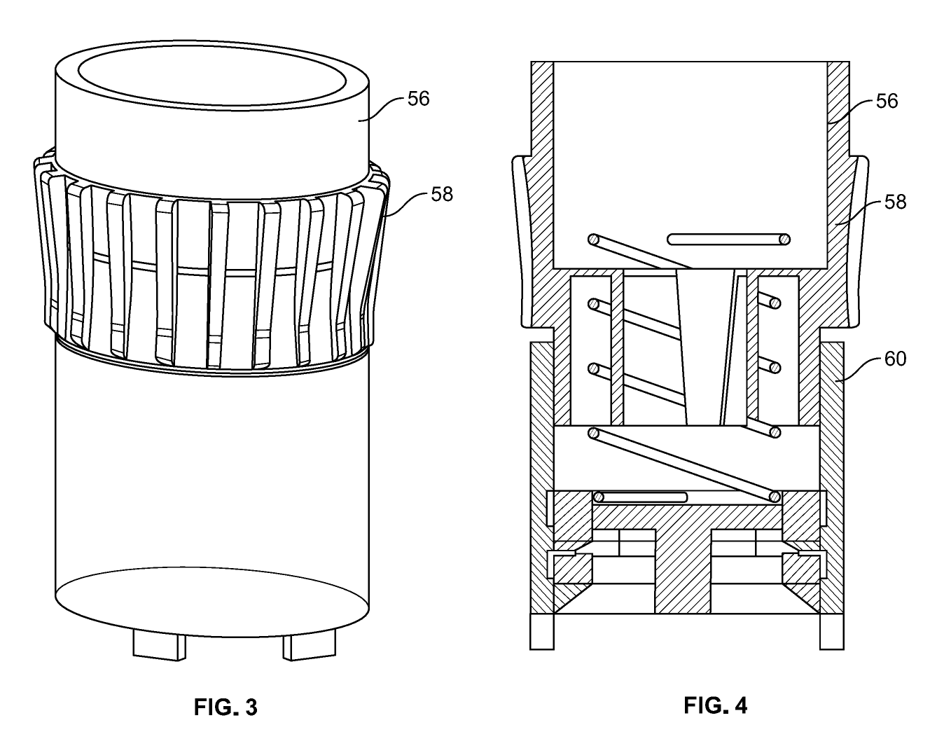

Beverage bottle 30 is mounted within cooled interior section 42 of housing 12 by locking socket 56. Locking socket 56 provides a circumferential array of tapered locking splines 58 (FIG. 3) adapted to securely engage a complimentary set of locking splines on a mounting manifold 60 as described in copending U.S. application Ser. No. 12/048,618, the subject matter of which is hereby incorporated herein in its entirety.

Beverage cooled to the ambient temperature of cooled interior portion 42 flows from inverted bottle 30 through locking socket 56 and mounting manifold 60 to beverage storage tank 62. In the embodiment illustrated, bottle 30 and mounting manifold 60 are placed above beverage storage tank 62 so fluid flow thereto may be achieved by gravity feed. In one embodiment of the present invention, beverage storage tank 40 may typically hold from 16-32 ounces of beverage, or more or less as may be desired.

A portion 64 of evaporator coil 52 is provided within sealed beverage storage tank 62 and provides a low pressure chamber for the liquid refrigerant to evaporate. The portion 64 of evaporator coil 52 within sealed beverage tank 62 absorbs ambient heat from the beverage within beverage storage tank 62 prior to its dispensation from beverage faucet 24. Desirably, the ambient temperature within cooled interior section 42 is maintained at a temperature from 25° to 40° F. and so prechills beverage within bottle 30 to that temperature. Portion 64 of evaporation coil 52 within beverage storage tank 62 serves to further chill the beverage, ideally down to a temperature of from about −5 to 30° F., preferably from 10° F. to 25° F., for dispersing through beverage faucet 24.

The machine 10 for dispensing a chilled beverage in accordance with the pending claims may preferably feature a housing wall or walls comprising integrated back-lighted billboard display panels as taught by U.S. Pat. No. 7,841,113, the subject matter of which is hereby incorporated herein in its entirety.

The inventors have determined that consumers desire to quickly obtain a consumable portion of beverage. A consumable portion of the cooled liquor is typically a shot, e.g., from 1½-2 fluid ounces and is intended to be delivered within 2-4 seconds, preferably 2½-3½ seconds, more preferably about 3 seconds. Given the viscous nature of highly cooled syrupy beverages, the inventor has further determined that, even if beverage storage tank 62 is located higher than beverage faucet 24, it may nevertheless be desirable to provide an electric fluid pump fluidly connecting beverage storage tank 62 to beverage faucet 24.

Providing an electric fluid pump is especially advantageous for thick beverages which may have a consistency similar to thick honey when chilled down to 15° F. and thereabouts. Accordingly, if the beverage is an alcoholic beverage that becomes very viscous when highly chilled, beverage storage tank 62 preferably features an electric fluid pump which is controlled by a microswitch or optical switch (unillustrated) operated by displacing beverage faucet 24, and pumps beverage from the interior of beverage storage tank 62 through beverage supply line 66.

As discussed, an electrical microswitch (unillustrated) actuates on-off operation of the beverage delivery pump. The beverage faucet 24 includes a handle 26 pivotally mounted thereon with an actuator to the electrical microswitch. The electrical microswitch may be any suitable, durable microswitch for use in dirty environments, such as an optical or ultrasonic switch. The switch is engaged when handle 26 has been displaced and so obviates the need for an independently operated pump switch or mechanical switches using push rod actuators. The microswitch is preferably activated when handle 26 is moved as little as two millimeters.

It should be understood that the foregoing description of the invention is intended merely to be illustrative thereof, and that other embodiments, modifications, and equivalents may be apparent to those skilled in the art without departing from its spirit.

What is claimed is:

1. A machine for dispensing chilled alcoholic beverage, comprising:
a housing forming an enclosure having side and bottom surfaces and a removable top, said housing being dimensioned so as to be placed on the countertop of a bar, and providing a beverage faucet mounted on a front outer surface of said housing, said beverage faucet having a movable handle for displacing a faucet stop and dispensing said alcoholic beverage;
said enclosure providing an insulating wall mounted within said housing, said insulating wall extending substantially from side-to-side and from top-to-bottom of said enclosure thereby providing a first enclosed portion adjacent said front outer surface of said housing and a second enclosed position adjacent a rear outer surface of said housing;
a refrigeration cooling unit contained within said housing, said refrigeration cooling unit including a compressor, condenser and evaporator coil, at least said compressor being located in said second enclosed portion and said evaporator coil being located so as to cool said first enclosed portion;
a beverage container mount provided within said first enclosed portion that removably mounts one inclined beverage container, said mounted beverage container being fluidly connected to a beverage storage tank within said first enclosed portion, said beverage storage tank containing therein at least a portion of said evaporator coil; and
a beverage delivery tube contained within said first enclosed portion fluidly connecting said beverage storage tank to said beverage faucet for delivering chilled beverage from said beverage storage tank to said beverage faucet at about −5 to 30° F.

2. The machine for dispensing chilled alcoholic beverage according to claim 1, wherein said first enclosed portion is chilled to 25°-40° F.

3. The machine for dispensing chilled alcoholic beverage according to claim 2, wherein said beverage storage tank is fed from said inclined beverage container by gravity.

4. The machine for dispensing chilled alcoholic beverage according to claim 3, wherein said beverage faucet is fed from said beverage storage tank by gravity.

5. The machine for dispensing chilled alcoholic beverage according to claim 3, wherein said beverage is delivered to said beverage faucet using an electric beverage pump, said beverage pump being controlled by a switch operated when said beverage faucet is opened.

6. The machine for dispensing chilled alcoholic beverage according to claim 5, wherein said switch is a microswitch.

7. The machine for dispensing chilled alcoholic beverage according to claim 5, wherein said switch is an optical switch.

8. The machine for dispensing chilled alcoholic beverage of claim 5, wherein said beverage pump is located within said insulated storage tank.
